(19) United States
(12) Patent Application Publication
(10) Pub. No.: US 2016/0133257 A1
(43) Pub. Date: May 12, 2016

(54) METHOD FOR DISPLAYING TEXT AND ELECTRONIC DEVICE THEREOF

(71) Applicant: Samsung Electronics Co., Ltd., Gyeonggi-do (KR)

(72) Inventors: Bo-Ram NAMGOONG, Seoul (KR); Eun-Gon KIM, Gyeonggi-do (KR); Myung-Suk BAEK, Gyeonggi-do (KR)

(73) Assignee: Samsung Electronics Co., Ltd.

(21) Appl. No.: 14/934,835

(22) Filed: Nov. 6, 2015

(30) Foreign Application Priority Data
Nov. 7, 2014 (KR) 10-2014-0154544

(51) Int. Cl. G10L 15/26; G10L 15/25; G10L 25/90; G10L 17/00

(52) U.S. Cl. CPC G10L 15/26; G10L 17/00; G10L 15/25; G10L 25/90

(57) ABSTRACT

A method of operating an electronic device is provided, which includes comparing gain values acquired on the basis of voices collected from at least two microphones, determining at least one speaker included in a displayed content on the basis of the compared gain values, and displaying a voice of the determined speaker in a text format in an area of a display around the determined speaker.

### PRIORITY

This application claims priority under 35 U.S.C. §119(a) to a Korean Patent Application filed in the Korean Intellectual Property Office on Nov. 7, 2014 and assigned Serial No. 10−2014−0154544, the entire disclosure of which is incorporated herein by reference.

### BACKGROUND

1. Field of the Invention

The present invention relates to a method for displaying a text and an electronic device thereof.

2. Description of the Related Art

With the advance of electronic devices, various functions can be performed by using one electronic device. For example, the electronic device can perform telephony, can transmit and receive a text message, can display games, the Internet, and various moving pictures, or can capture a high-quality image or moving picture.

For example, the electronic device may capture moving pictures, and may display a voice acquired from a surrounding environment in a text format. However, when a moving picture is captured in an electronic device, if it is intended to attach a voice acquired from a surrounding environment to the moving picture, two separate tasks, i.e., capturing the moving picture and recording only the voice, are required.

### SUMMARY

The present invention has been made to solve at least the above-mentioned problems and/or disadvantages and to provide at least the advantages described below.

Accordingly, an aspect of the present invention is to provide an apparatus and method in which a speaker included in a content is determined by using a gain value, face recognition information, voice frequency information, or the like acquired from at least two equipped microphones, and thereafter a voice of the speaker is displayed in a text format in a predetermined area, so that even a hearing-challenged person can easily check voice information.

Another aspect of the present invention is to provide an apparatus and method in which voice information can be acquired while capturing content, thereby being able to improve a user's convenience.

Another aspect of the present invention is to provide an apparatus and method in which a stored content can be edited according to a user's preference, thereby being able to satisfy user's various demands.

According to an aspect of the present invention, a method of operating an electronic device is provided, which includes comparing gain values acquired on the basis of voices collected from at least two microphones, determining at least one speaker included in a displayed content on the basis of the compared gain values, and displaying a voice of the determined speaker in a text format in an area of a display around the determined speaker.

According to another aspect of the present invention, an electronic device is provided, which includes a processor for comparing gain values acquired on the basis of voices collected from at least two microphones and for determining a speaker included in a captured content on the basis of the compared gain values, and a display for displaying a voice of the determined speaker in a text format in an area of the display around the determined speaker.

### BRIEF DESCRIPTION OF THE DRAWINGS

The above and other aspects, features and advantages of certain embodiments of the present invention will be more apparent from the following detailed description, taken in conjunction with the accompanying drawings, in which:

FIG. 1 illustrates a network environment 100 including an electronic device 101 according to an embodiment of the present invention;

FIG. 2 illustrates a block diagram 200 of an electronic device 201 according to an embodiment of the present invention;

FIG. 3 illustrates an example of determining a location of a speaker according to an embodiment of the present invention of the present invention;

FIG. 4 illustrates an example of determining a location of a speaker by using a face recognition function according to an embodiment of the present invention;

FIG. 5 illustrates an example of determining a speaker by using a gain value, face recognition information, and frequency information according to an embodiment of the present invention;

FIGS. 6A-6D illustrate an example of displaying a voice of a speaker in a text format according to an embodiment of the present invention;

FIG. 7 illustrates an example of selecting a displayed speaker's voice according to an embodiment of the present invention;

FIGS. 8A and 8B illustrate an example of displaying a speaker's voice in a text format on the basis of a pre-set priority according to an embodiment of the present invention;

FIG. 9 illustrates an example of displaying a speaker's voice in a text format when a speaker is not displayed in a display according to an embodiment of the present invention;

FIGS. 10A and 10B display an augmented reality of an electronic device according to an embodiment of the present invention;

FIG. 11 is a flowchart illustrating an operation of an electronic device according to an embodiment of the present invention; and

FIG. 12 is a flowchart illustrating a method of an electronic device according to an embodiment of the present invention.

### DETAILED DESCRIPTION OF EMBODIMENTS OF THE PRESENT INVENTION

The following description with reference to the accompanying drawings is provided to assist in a comprehensive understanding of the present invention as defined by the claims and their equivalents. It includes various specific details to assist in that understanding but these are to be regarded merely as examples. Accordingly, those of ordinary skill in the art will recognize that various changes and modifications of the various embodiments described herein can be made without departing from the scope and spirit of the present invention. In addition, descriptions of well-known functions and constructions may be omitted for clarity and conciseness.

The terms and words used in the following description and claims are not limited to their meanings in a dictionary, but are merely used to enable a clear and consistent understanding of the present invention. Accordingly, it should be apparent to those skilled in the art that the following description of various embodiments of the present invention is provided for illustration purposes only and not for the purpose of limiting the present invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The expressions “include” and/or “may include” used in the present disclosure are intended to indicate a presence of a corresponding function, operation, or element, and are not intended to limit a presence of one or more functions, operations, and/or elements. In addition, in the present disclosure, the terms “include” and/or “have” are intended to indicate that characteristics, numbers, operations, elements, and components disclosed in the specification or combinations thereof exist. As such, the terms “include” and/or “have” should be understood to mean that there are additional possibilities of one or more other characteristics, numbers, operations, elements, elements or combinations thereof. In the present disclosure, the expression “or” includes any and all combinations of words enumerated together. For example, “A or B” may include A or B, or may include both A and B.

Although expressions such as “1^{st},” “2^{nd},” “first,” and “second” may be used to express various elements of the present invention, they are not intended to limit the corresponding elements. For example, the above expressions are not intended to limit an order or an importance of the corresponding elements. The above expressions may be used to distinguish one element from another element. For example, a 1^{St} user device and a 2^{nd} user device are both user devices, and indicate different user devices. For example, a 1^{St} element may be referred to as a 2^{nd} element, and similarly, the 2^{nd} element may be referred to as the 1^{st} element without departing from the scope of the present invention.

When an element is mentioned as being “connected” to or “accessing” another element, this may mean that it is directly connected to or accessing the other element, but it is to be understood that there may be intervening elements present. Alternatively, when an element is mentioned as being “directly connected” to or “directly accessing” another element, it is to be understood that there are no intervening elements present.

The term “module” used in various embodiments of the present invention may, for example, represent units including one or a combination of two or more of hardware, software, and firmware. The “module” may be used interchangeably with the terms “unit,” “logic,” “logical block,” “component,” “circuit” and the like, for example. The “module” may be the minimum unit of an integrally constructed component or part thereof. The “module” may be also the minimum unit performing one or more functions or part thereof. The “module” may be implemented mechanically or electronically. For example, the “module” according to various embodiments of the present invention may include at least one of an Application-Specific IC (ASIC) chip, Field-Programmable Gate Arrays (FPGAs) and a programmable logic device performing some operations known to the art or to be developed in the future.

The terminology used in the present disclosure is for the purpose of describing particular embodiments only and is not intended to be limiting of the present invention. A singular expression includes a plural expression unless there is a contextually distinctive difference therebetween.

Unless otherwise defined, all terms (including technical and scientific terms) used herein have the same meaning as commonly understood by those ordinarily skilled in the art to which the present invention belongs. It will be further understood that terms, such as those defined in commonly used dictionaries, should be interpreted as having meanings that are consistent with their meaning in the context of the relevant art and the present disclosure, and will not be interpreted in an idealized or overly formal sense unless expressly so defined herein.

An electronic device according to various embodiments of the present invention may be a device including a communication function. For example, the electronic device may include at least one of a smart phone, a tablet Personal Computer (PC), a mobile phone, a video phone, an e-book reader, a desktop PC, a laptop PC, a netbook computer, a Personal Digital Assistant (PDA), a Portable Multimedia Player (PMP), an MPEG-1 Audio Layer 3 (MP3) player, a mobile medical device, a camera, and a wearable device (e.g., a Head-Mounted-Device (HMD) such as electronic glasses, electronic clothes, an electronic bracelet, an electronic necklace, an electronic appcessory, an electronic tattoo, or a smart watch).

According to various embodiments of the present invention, the electronic device may be a smart home appliance having a communication function. For example, the smart home appliance may include at least one of a Television (TV), a Digital Versatile Disc (DVD) player, an audio player, a refrigerator, an air conditioner, a cleaner, an oven, a microwave oven, a washing machine, an air purifier, a set-top box, a TV box (e.g., Samsung HomeSync™, Apple TV™, or Google TV™), a game console, an electronic dictionary, an electronic key, a camcorder, and an electronic picture frame.

According to various embodiments of the present invention, the electronic device may include at least one of various medical devices (e.g., Magnetic Resonance Angiography (MRA), Magnetic Resonance Imaging (MRI), Computed Tomography (CT), imaging equipment, ultrasonic instrument, and the like), a navigation device, a Global Positioning System (GPS) receiver, an Event Data Recorder (EDR), a Flight Data Recorder (FDR), a car infotainment device, an electronic equipment for ship (e.g., a vessel navigation device, a gyro compass, and the like), avionics, a security device, and an industrial or domestic robot.

According to various embodiments of the present invention, the electronic device may include at least one of furniture or a part of building/constructions including a screen output function, an electronic board, an electronic signature receiving device, a projector, and various measurement machines (e.g., a water supply measurement machine, an electricity measurement machine, a gas measurement machine, a propagation measurement machine, and the like). The electronic device according to various embodiments of the present invention may be one or more combinations of the aforementioned various devices. In addition, it is apparent those ordinarily skilled in the art that the electronic device according to the present invention is not limited to the aforementioned devices.

According to an embodiment of the present invention, the electronic device may include a plurality of displays capable of a screen output, and may output one screen by using the plurality of displays as one display or may output a screen to each display. According to an embodiment of the present invention, the plurality of displays may be connected with a connection portion, for example, a hinge, to be movable in a specific angle according to a fold-in or fold-out manner.

According to an embodiment of the present invention, the electronic device may include a flexible display, and may output a screen by using the flexible display as one display or by dividing a display area into a plurality of parts with respect to a portion of the flexible display.

According to an embodiment of the present invention, the electronic device may be equipped with a cover having a display protection function capable of a screen output. According to an embodiment of the present invention, the electronic device may output one screen by using a display of the cover and a display of the electronic device as one display or may output a screen to each display.

Hereinafter, an electronic device according to various embodiments of the present invention will be described with reference to the accompanying drawings. The term “user” used in the various embodiments of the present invention may refer to a person who uses the electronic device or a device (e.g., an Artificial Intelligence (AI) electronic device) which uses the electronic device.

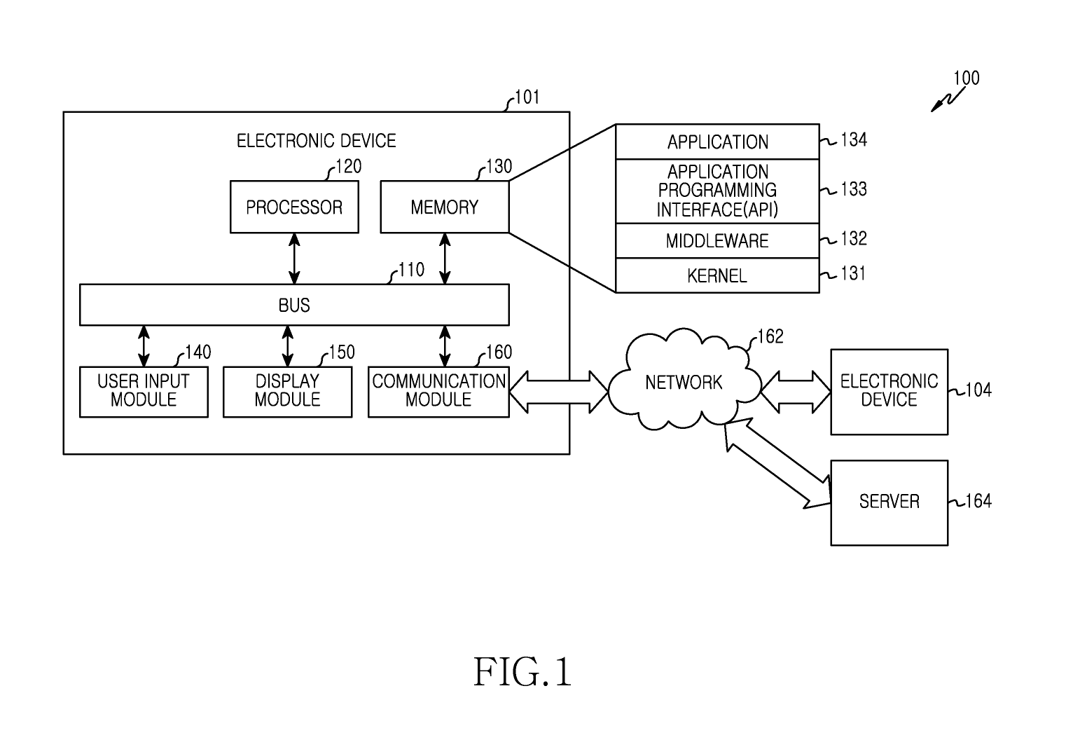

FIGS. 1 through 12, discussed below, and the various embodiments used to describe the principles of the present invention in this specification are by way of illustration only and should not be construed in any way that would limit the scope of the invention. Those skilled in the art will understand that the principles of the present invention may be implemented in any suitably arranged communications system. The terms used to describe various embodiments are only examples. It should be understood that these are provided to merely aid the understanding of the description, and that their use and definitions do not limit the scope of the present invention. Terms “first”, “second”, and the like are used to differentiate between objects having the same terminology and are in no way intended to represent a chronological order, unless where explicitly stated otherwise. The term “a set” is defined as a non-empty set including at least one element.

FIG. 1 illustrates a network environment including an electronic device according to an embodiment of the present invention.

Referring to FIG. 1, an electronic device 101 may include a bus 110, a processor 120, a memory 130, a user input module 140, a display module 150, and a communication module 160.

The bus 110 is a circuit for connecting the aforementioned elements to each other and for delivering communication (e.g., a control message) between the aforementioned elements.

The processor 120 receives an instruction from the aforementioned different elements (e.g., the memory 130, the user input module 140, the display module 150, and/or the communication module 160), for example, via the bus 110, and thus interprets the received instruction and executes arithmetic or data processing according to the interpreted instruction.

The memory 130 stores an instruction or data received from the processor 120 or different elements (e.g., the user input module 140, the display module 150, and/or the communication module 160) or generated by the processor 120 or the different elements. The memory 130 may include programming modules such as a kernel 131, middleware 132, an Application Programming Interface (API) 133, an application 134, and the like. Each of the aforementioned programming modules may consist of software, firmware, or hardware entities or may consist of at least two or more combinations thereof.

The kernel 131 controls or manages the remaining other programming modules, for example, system resources (e.g., the bus 110, the processor 120, the memory 130, and the like) used to execute an operation or function implemented in the middleware 132, the API 133, or the application 134. In addition, the kernel 131 provides a controllable or manageable interface by accessing individual elements of the electronic device 101 in the middleware 132, the API 133, or the application 134.

The middleware 132 performs a mediation role such that the API 133 or the application 134 communicates with the kernel 131 to exchange data. In addition, regarding task requests received from the application 134, for example, the middleware 132 may perform a control (e.g., scheduling or load balancing) for the task requests by using a method of assigning a priority capable of using a system resource (e.g., the bus 110, the processor 120, the memory 130, and the like) of the electronic device 101 to at least one application 134.

The API 133 may include at least one interface or function (e.g., instruction) for file control, window control, video processing, character control, and the like, as an interface capable of controlling a function provided by the application 134 in the kernel 131 or the middleware 132.

According to various embodiments of the present invention, the application 134 may include a Short Message Service (SMS)/Multimedia Messaging Service (MMS) application, an e-mail application, a calendar application, an alarm application, a health care application (e.g., an application for measuring a physical activity level, a blood sugar, and the like) or an environment information application (e.g., atmospheric pressure, humidity, or temperature information). Alternatively, the application 134 may be an application related to an information exchange between the electronic device 101 and an external electronic device 104. The application related to the information exchange may include, for example, a notification relay application for relaying specific information to the external electronic device 104 or a device management application for managing the external electronic device 104.

For example, the notification relay application may include a function of relaying notification information generated in another application (e.g., an SMS/MMS application, an e-mail application, a health care application, an environment information application, and the like) of the electronic device 101 to the external electronic device 104. Alternatively, the notification relay application may receive notification information, for example, from the external electronic device 104 and may provide it to the user. The device management application may manage, for example, a function for at least one part of the external electronic device 104, which communicates with the electronic device 101. Examples of the function include turning on/turning off the external electronic device itself (or some components thereof) or adjusting of a display illumination (or a resolution), and managing (e.g., installing, deleting, or updating) of an application which operates in the external electronic device 104 or a service (e.g., a call service or a message service) provided by the external electronic device 104.

According to various embodiments of the present invention, the application 134 may include an application specified according to attribute information (e.g., an electronic device type) of the external electronic device 104. For example, if the external electronic device 104 is an MP3 player, the application 134 may include an application related to a music play. Similarly, if the external electronic device 104 is a mobile medical device, the application 134 may include an application related to a health care. According to an embodiment of the present invention, the application 134 may include at least one of a specified application in the electronic device 101 or an application received from the external electronic device 104 or a server 106.

The user input module 140 relays an instruction or data input from a user via an input/output device (e.g., a sensor, a keyboard, and/or a touch screen) to the processor 120, the memory 130, the communication module 160, for example, via the bus 110. For example, the user input module 140 may provide data regarding a user's touch input via the touch screen to the processor 120. In addition, the user input module 140 outputs an instruction or data received from the processor 120, the memory 130, the communication module 160 to an output device (e.g., a speaker and/or a display), for example, via the bus 110. For example, the user input module 140 may output audio data provided by using the processor 120 to the user via the speaker.

The display module 150 displays a variety of information (e.g., multimedia data or text data) to the user.

The communication module 160 connects a communication between the electronic device 101 and an external device (e.g., the electronic device 104, or the server 106). For example, the communication module 160 may communicate with the external device by being connected with a network 162 through wireless communication or wired communication. For example, the wireless communication may include at least one of Wi-Fi, Bluetooth (BT), Near Field Communication (NFC), a GPS, and cellular communication (e.g., Long Term Evolution (LTE), LTE-Advanced (LTE-A), Code Division Multiple Access (CDMA), Wideband CDMA (WCDMA), Universal Mobile Telecommunications System (UMTS), Wireless Broadband (WiBro), Global System for Mobile Communications (GSM), and the like). For example, the wired communication may include at least one of Universal Serial Bus (USB), High Definition Multimedia Interface (HDMI), Recommended Standard (RS)-232, and Plain Old Telephone Service (POTS).

According to an embodiment of the present invention, the network 162 may be a telecommunications network. The telecommunications network may include at least one of a computer network, an Internet, an Internet of Things, and a telephone network. According to an embodiment of the present invention, a protocol (e.g., a transport layer protocol, a data link layer protocol, or a physical layer protocol) for a communication between the electronic device 101 and the external device may be supported in at least one of the application 134, the API 133, the middleware 132, the kernel 131, and the communication module 160.

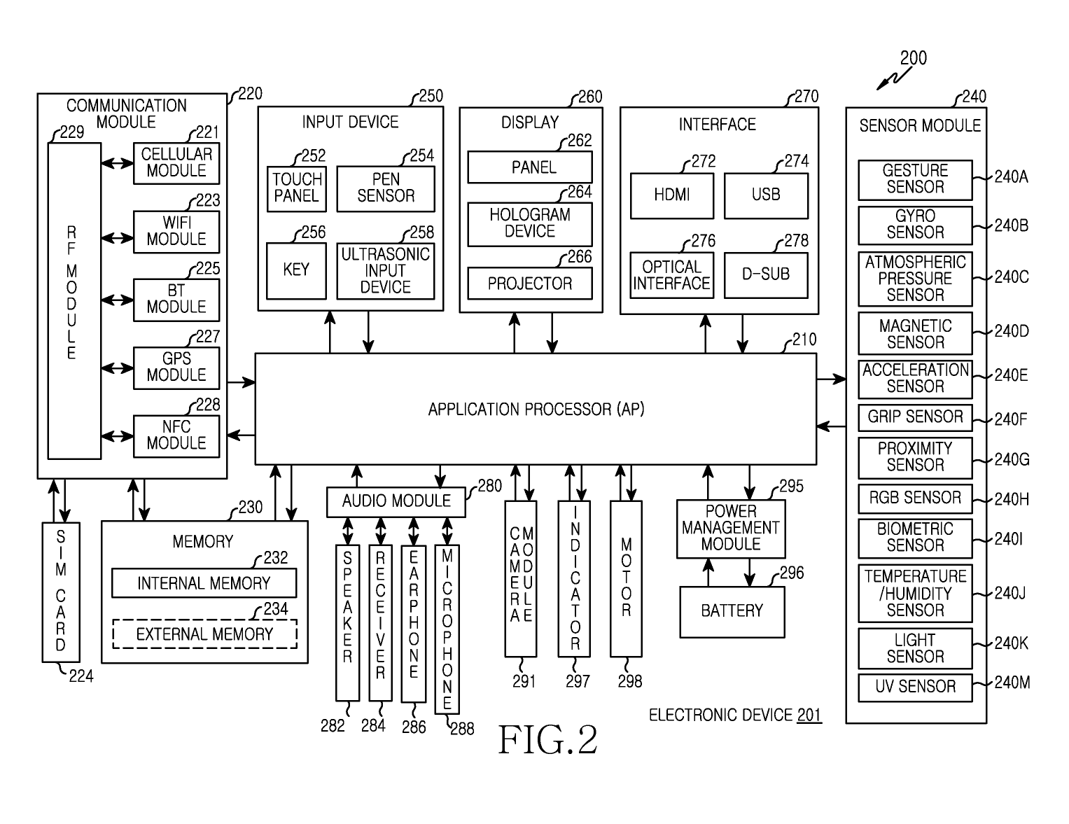

FIG. 2 is a block diagram illustrating a configuration of an electronic device according to an embodiment of the present invention.

Referring to FIG. 2, a block diagram 200 including an electronic device 201 is illustrated. The electronic device 201 may, for example, construct the whole or part of the electronic device 101 illustrated in FIG. 1. As illustrated in FIG. 2, the electronic device 201 may include one or more Application Processors (APs) 210, a communication module 220, a Subscriber Identification Module (SIM) card 224, a memory 230, a sensor module 240, an input device 250, a display 260, an interface 270, an audio module 280, a camera module 291, a power management module 295, a battery 296, an indicator 297, and a motor 298.

The AP 210 drives an operating system or application program and controls a plurality of hardware or software constituent elements connected to the AP 210. The AP 210 performs processing and operations of various data including multimedia data. The AP 210 may be, for example, implemented as a System on Chip (SoC). According to an embodiment of the present invention, the AP 210 may further include a Graphic Processing Unit (GPU).

The communication module 220 (e.g., the communication module 160, as illustrated in FIG. 1) performs data transmission/reception in communication between other electronic devices (e.g., the electronic device 104 or the server 106, as illustrated in FIG. 1) connected with the electronic device 201 (e.g., the electronic device 101, as illustrated in FIG. 1) through a network. According to an embodiment of the present invention, the communication module 220 may include a cellular module 221, a Wi-Fi module 223, a BT module 225, a GPS module 227, an NFC module 228, and a Radio Frequency (RF) module 229.

The cellular module 221 provides voice telephony, video telephony, a text service, an Internet service and the like through a communication network (e.g., LTE, LTE-A, CDMA, WCDMA, UMTS, WiBro, GSM or the like). Also, the cellular module 221 may, for example, perform electronic device distinction and authorization within a communication network using the SIM card 224. According to an embodiment of the present invention, the cellular module 221 performs at least some functions among functions that the AP 210 can provide. For example, the cellular module 221 may perform at least a part of a multimedia control function.

According to an embodiment of the present invention, the cellular module 221 may include a Communication Processor (CP). Also, the cellular module 221 may be, for example, implemented as an SoC. Referring to FIG. 2, the constituent elements such as the cellular module 221, the memory 230, the power management module 295 and the like are illustrated as constituent elements separated from the AP 210. However, according to an embodiment of the present invention, the AP 210 may be implemented to include at least some (e.g., the cellular module 221) of the aforementioned constituent elements.

According to an embodiment of the present invention, the AP 210 or the cellular module 221 loads to a volatile memory an instruction or data received from a nonvolatile memory connected to each of the AP 210 and the cellular module 221 or at least one of other constituent elements, and processes the loaded instruction or data. Also, the AP 210 or the cellular module 221 stores data received from at least one of other constituent elements or generated in at least one of the other constituent elements, in the nonvolatile memory.

The Wi-Fi module 223, the BT module 225, the GPS module 227, and the NFC module 228 may each include a processor for processing data transmitted/received through the corresponding module, for example. In FIG. 2, each of the cellular module 221, the Wi-Fi module 223, the BT module 225, the GPS module 227 and the NFC module 228 is illustrated as a separate block. However, according to an embodiment of the present invention, at least some (e.g., two) of the cellular module 221, the Wi-Fi module 223, the BT module 225, the GPS module 227 and the NFC module 228 may be included within one Integrated Circuit (IC) or IC package. For example, at least some processors corresponding to the cellular module 221, the Wi-Fi module 223, the BT module 225, the GPS module 227 and the NFC module 228, for example, a communication processor corresponding to the cellular module 221 and a Wi-Fi processor corresponding to the Wi-Fi module 223 may be implemented as one SoC.

The RF module 229 performs data transmission/reception, for example, RF signal transmission/reception. The RF module 229 may include, though not illustrated, a transceiver, a Power Amp Module (PAM), a frequency filter, a Low Noise Amplifier (LNA) or the like, for example. Also, the RF module 229 may further include components, for example, a conductor, a conductive line and the like for transmitting/receiving an electromagnetic wave on a free space in wireless communication. Referring to FIG. 2, it is illustrated that the cellular module 221, the Wi-Fi module 223, the BT module 225, the GPS module 227, and the NFC module 228 share one RF module 229 with each other. However, according to an embodiment of the present invention, at least one of the cellular module 221, the Wi-Fi module 223, the BT module 225, the GPS module 227, and the NFC module 228 may perform RF signal transmission/reception through a separate RF module.

The SIM card 224 may be inserted into a slot provided in a specific location of the electronic device 201. The SIM card 224 may include unique identification information (e.g., an Integrated Circuit Card ID (ICCID)) or subscriber information (e.g., an International Mobile Subscriber Identity (IMSI)).

The memory 230 (e.g., the memory 130, as illustrated in FIG. 1) may include an internal memory 232 and/or an external memory 234. The internal memory 232 may, for example, include at least one of a volatile memory (e.g., a Dynamic Random Access Memory (DRAM), a Static RAM (SRAM), a Synchronous DRAM (SDRAM) and the like) and a nonvolatile memory (e.g., a One-Time Programmable Read Only Memory (OTPROM), a PROM, an Erasable and Programmable ROM (EPROM), an Electrically Erasable and Programmable ROM (EEPROM), a mask ROM, a flash ROM, a Not AND (NAND) flash memory, a Not OR (NOR) flash memory and the like).

According to an embodiment of the present invention, the internal memory 232 may be a Solid State Drive (SSD). The external memory 234 may include a flash drive, for example, Compact Flash (CF), Secure Digital (SD), micro-SD, Mini-SD, extreme Digital (xD), a memory stick or the like. The external memory 234 may be functionally connected with the electronic device 201 through various interfaces. According to an embodiment of the present invention, the electronic device 201 may further include a storage device (or storage media) such as a hard drive.

The sensor module 240 measures a physical quantity or senses an activation state of the electronic device 201, and converts measured or sensed information into an electrical signal. The sensor module 240 may, for example, include at least one of a gesture sensor 240A, a gyro sensor 240B, an air (atmospheric) pressure sensor 240C, a magnetic sensor 240D, an acceleration sensor 240E, a grip sensor 240F, a proximity sensor 240G, a color sensor 240H (e.g., a Red, Green, Blue (RGB) sensor), a bio-physical (biometric) sensor 240I, a temperature/humidity sensor 240J, an illumination (light) sensor 240K, and a Ultraviolet (UV) sensor 240M. Alternatively, the sensor module 240 may, for example, include an E-nose sensor, an Electromyography (EMG) sensor, an Electroencephalogram (EEG) sensor, an Electrocardiogram (ECG) sensor, an Infrared (IR) sensor, an iris sensor, a fingerprint sensor and the like. The sensor module 240 may further include a control circuit for controlling at least one or more sensors belonging therein.

The input device 250 may include a touch panel 252, a (digital) pen sensor 254, a key 256, and an ultrasonic input device 258. The touch panel 252, for example, recognizes a touch input in at least one method among a capacitive overlay method, a pressure sensitive method, an infrared beam method, and an acoustic wave method. Also, the touch panel 252 may further include a control circuit. In the capacitive overlay method, physical contact or proximity recognition is possible. The touch panel 252 may further include a tactile layer. In this case, the touch panel 252 provides a tactile response to a user.

The (digital) pen sensor 254 may be, for example, implemented using the same or similar method to that of receiving a user's touch input or a separate sheet for recognition. The key 256 may, for example, include a physical button, an optical key, a keypad, or a touch key. The ultrasonic input device 258 is a device capable of confirming data by sensing a sound wave with a microphone 288 of the electronic device 201 through an input tool generating an ultrasonic signal. The ultrasonic input device 258 is possible to perform wireless recognition.

According to an embodiment of the present invention, by using the communication module 220, the electronic device 201 may receive a user input from an exterior device (e.g., a computer or a server) connected to the communication module 220.

The display 260 (e.g., the display module 150, as illustrated in FIG. 1) may include a panel 262, a hologram device 264, and a projector 266. The panel 262 may be, for example, a Liquid Crystal Display (LCD), an Active-Matrix Organic Light-Emitting Diode (AMOLED) or the like. The panel 262 may be, for example, implemented to be flexible, transparent, or wearable. The panel 262 may be also constructed together with the touch panel 252 as one module. The hologram device 264 shows a three-dimensional image in the air using interference of light. The projector 266 displays a video by projecting light to a screen. The screen can be, for example, located inside or outside the electronic device 201. According to an embodiment of the present invention, the display 260 may further include a control circuit for controlling the panel 262, the hologram device 264, and the projector 266.

The interface 270 may, for example, include an HDMI 272, a USB 274, an optical interface 276, or a D-subminiature (D-sub) 278. The interface 270 may be, for example, included in the communication module 160 illustrated in FIG. 1. Alternatively, the interface 270 may, for example, include a Mobile High-definition Link (MHL) interface, a Secure Digital/Multi Media Card (SD/MMC) interface, or an Infrared Data Association (IrDA) standard interface.

The audio module 280 converts sound and an electric signal interactively. At least some constituent elements of the audio module 280 may be, for example, included in the input/output interface 20, as illustrated in FIG. 1. The audio module 280 may process sound information inputted or outputted through a speaker 282, a receiver 284, earphones 286, the microphone 288, or the like, for example.

The camera module 291 is a device capable of taking a still picture and a moving picture. According to an embodiment of the present invention, the camera module 291 may include one or more image sensors (e.g., a front sensor or rear sensor), a lens, an Image Signal Processor (ISP), or a flash (e.g., an LED or a xenon lamp).

The power management module 295 manages power of the electronic device 201. Though not illustrated, the power management module 295 may include, for example, a Power Management IC (PMIC), a charger IC, and a battery gauge.

The PMIC may be, for example, mounted within an integrated circuit or an SoC semiconductor. A charging method may be divided into wired and wireless charging methods. The charger IC may charge a battery, and may prevent the introduction of overvoltage or overcurrent from an electric charger. According to an embodiment of the present invention, the charger IC may include a charger IC of at least one of the wired charging method and the wireless charging method. The wireless charging method includes, for example, a magnetic resonance method, a magnetic induction method, an electromagnetic wave method and the like. Supplementary circuits for wireless charging, for example, circuits such as a coil loop, a resonance circuit, a rectifier and the like may be added.

The battery gauge may, for example, measure a level of the battery 296 and a voltage in charging, an electric current, and a temperature. The battery 296 may store and generate electricity, and may supply a power source to the electronic device 201 using the stored or generated electricity. The battery 296 may, for example, include a rechargeable battery or a solar battery.

The indicator 297 displays a specific state of the electronic device 201 or part (e.g., the AP 210) thereof, for example, a booting state, a message state, a charging state or the like. The motor 298 converts an electrical signal into a mechanical vibration. Though not illustrated, the electronic device 201 may include a processing device (e.g., a GPU) for mobile TV support. The processing device for mobile TV support may process media data according to the standards of Digital Multimedia Broadcasting (DMB), Digital Video Broadcasting (DVB), a media flow or the like, for example.

The aforementioned constituent elements of an electronic device according to various embodiments of the present invention may be each comprised of one or more components, and a name of the corresponding constituent element may be different according to the kind of the electronic device. The electronic device according to the various embodiments of the present invention may include at least one of the aforementioned constituent elements, and may omit some constituent elements or further include additional other constituent elements. Also, some of the constituent elements of the electronic device according to various embodiments of the present invention are combined and constructed as one entity, thereby being able to identically perform the functions of the corresponding constituent elements before combination.

According to an embodiment of the present invention of the present invention, an electronic device may include a processor for comparing gain values acquired on the basis of voices collected from at least two microphones upon detecting a content capturing action and for determining at least one subject as a speaker included in a captured content on the basis of the compared gain values, and a display for displaying a voice of the determined speaker in a text format in a pre-set area of the display around the determined speaker.

The content capturing action may include displaying a preview image of the content and starting a face recognition function in the preview image.

The processor may subtract a gain value acquired on the basis of a voice collected from a second microphone among the at least two microphones from a gain value acquired on the basis of a voice collected from a first microphone among the at least two microphones.

The processor may divide the display into at least two areas, and may determine whether the at least one subject is included in at least one area among the divided areas.

The processor may compare the gain values acquired from the at least two microphones to confirm that a value resulting from comparing the gain values is included in any one of decibel ranges of decibel areas which are configured to correspond to the divided areas, may detect an area matched to the decibel area having a specific decibel range including the value resulting from comparing the gain values among the divided areas, and may determine a subject included in the detected area as the speaker.

If at least two subjects are included in the detected area, the processor may acquire face information of the at least two subjects through a face recognition function, and may determine any one of the at least two subjects included in the detected area as the speaker.

The processor may acquire frequency information of the voices acquired from the at least two microphones, and if the acquired frequency information of the voices is lower than a pre-set frequency, may determine a gender of the subject as a male or determine an age of the subject as an adult.

The processor may acquire frequency information of the voices acquired from the at least two microphones, and if the acquired frequency information of the voice is greater than or equal to the pre-set frequency, may determine the gender of the subject as a female or determine the age of the subject as a minor.

The processor may convert the voice of the determined speaker into a text by using a Speech To Text (STT) technique, may list the converted text, and if there is a text of which a priority is set among the listed texts, may preferentially display the text having the priority in the pre-set area.

If there is an empty area having the same size as the pre-set area among upper, lower, left, and right areas around the determined speaker, the pre-set area may be an area determined on the basis of a determined order among the upper, lower, left, and right areas.

According to an embodiment of the present invention, when an electronic device detects an action of capturing content such as still or moving images, the electronic device may compare gain values acquired from at least two microphones equipped in the electronic device. Hereinafter, the gain value is referred to as a sound pressure level of a voice collected by a microphone (usually measured in units of dB). According to an embodiment of the present invention, when an image capturing action is detected in the electronic device, the speaker of the electronic device may be turned off while the at least two microphones are turned on. According to an embodiment of the present invention, the electronic device may start a face recognition function of a subject included in a preview image while displaying the preview image. According to an embodiment of the present invention, the electronic device having dual microphones may subtract a gain value acquired from a second microphone from a gain value acquired from a first microphone.

According to an embodiment of the present invention, the electronic device may determine a subject as a speaker included in a captured content. According to an embodiment of the present invention, the electronic device may divide a display of the electronic device into at least two areas, and thereafter may determine whether and confirm that at least one subject is included in one or more areas among the divided areas.

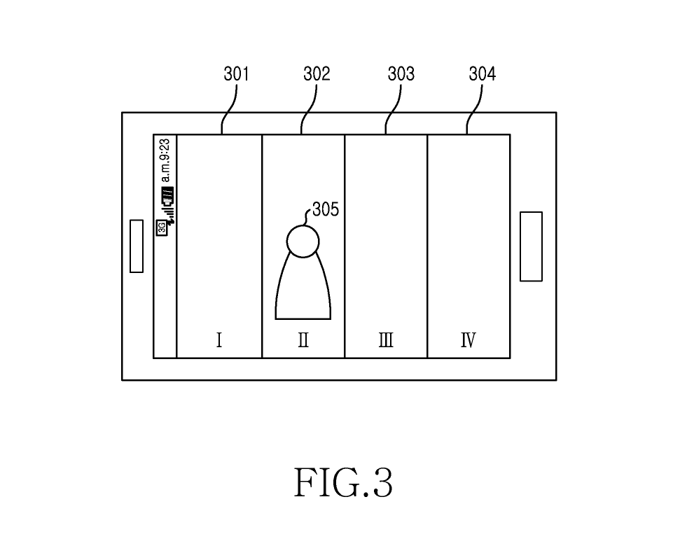

FIG. 3 illustrates an example of determining a location of a speaker according to an embodiment of the present invention.

As shown in FIG. 3, an electronic device may divide the display of the electronic device into first to fourth areas 301, 302, 303, and 304, and thereafter may confirm that a subject 305 is included in the second area 302 among the divided four areas 301, 302, 303, and 304. In FIG. 3, the areas are divided based on different decibel ranges.

According to an embodiment of the present invention, the electronic device may compare gain values acquired from at least two microphones. According to an embodiment of the present invention, a difference between gain values for voices acquired respectively from the at least two microphones may be calculated, and an area may be determined by using the calculated difference. According to an embodiment of the present invention, the electronic device may determine whether the calculated difference or a value resulted from comparing the gain values is included in any one of decibel ranges of decibel areas, which are configured to correspond to the divided areas of a display of the electronic device. As shown in FIG. 3, when dual microphones are equipped in the electronic device, the display of the electronic device is divided into the four areas 301, 302, 303, and 304, which correspond to a decibel area 301 (having a decibel range beyond 20 db, a decibel area 302 having a decibel range between 0 db and db, a decibel area 303 having a decibel range between −20 db and 0 db, and a decibel area 304 having a decibel range beyond below −20 db, respectively.

In the aforementioned example, if the calculated difference or the value resulting from comparing the gain values is 10 db, the electronic device may confirm that an area matched with the decibel area having a decibel range between 0 db and 20 db is the second area 302 among the divided four areas 301, 302, 303, and 304.

According to an embodiment of the present invention, the electronic device may determine a subject included in the confirmed area matched with the decibel area as the speaker. In the aforementioned example, the electronic device may determine the subject 305 included in the second area 302 as the speaker.

According to an embodiment of the present invention, the at least two microphones may be located facing each other at two ends of the display of the electronic device. According to an embodiment of the present invention, if the electronic device includes two microphones, one microphone may be placed to the uppermost portion of the display, and the other microphone may be placed to the lowest portion of the display of the electronic device.

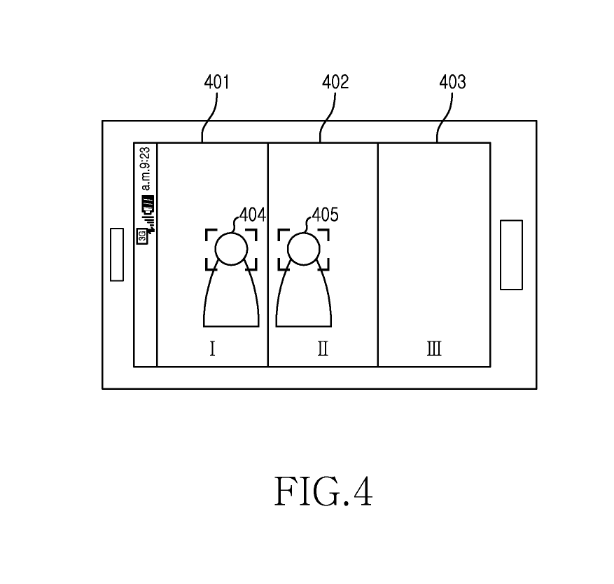

FIG. 4 illustrates an example of determining a location of a speaker by using a face recognition function according to an embodiment of the present invention.

According to an embodiment of the present invention, the electronic device may analyze a location of a recognized face of a subject displayed in a display, and thus may confirm that the analyzed location corresponds to at least one area among at least two divided areas of the display. As shown in FIG. 4, the display of the electronic device is divided into first to third areas 401, 402, and 403, and subjects 404 and 405 are located respectively in the first area 401 and the second area 402.

In the aforementioned example, the electronic device may recognize a face of each of the first subject 404 included in the first area 401 and the second subject 405 included in the second area 402. According to an embodiment of the present invention, the electronic device may determine whether voices acquired from at least two microphones are acquired from the first subject 404 or are acquired from the second subject 405.

According to an embodiment of the present invention, the electronic device may determine at least one subject as the speaker by matching face recognition information of a subject recognized from a face recognition function and location information of a subject based on voices acquired from a microphone. In the aforementioned example, if the electronic device recognizes that faces of the first subject 404 and the second subject 405 respectively as a male and a female and that the voice acquired from the microphone is acquired from the first area 401, the electronic device may determine the first subject 404 as the speaker. According to another example, if the electronic device recognizes that faces of the first subject 404 and the second subject 405 respectively as a male and a female and that the voice acquired from the microphone is acquired from the second area 402, the electronic device may determine the second subject 405 as the speaker.

According to an embodiment of the present invention, the electronic device may store acquired voice information and face recognition information, and thereafter may utilize the stored information in next capturing. According to an embodiment of the present invention, the electronic device may store face recognition information and voice information of the first subject 404 and the second subject 405, and thereafter if faces and voices of the first subject 404 or the second subject 405 are detected, the electronic device may directly determine that the acquired voice is acquired from the first subject 404 or the second subject 405.

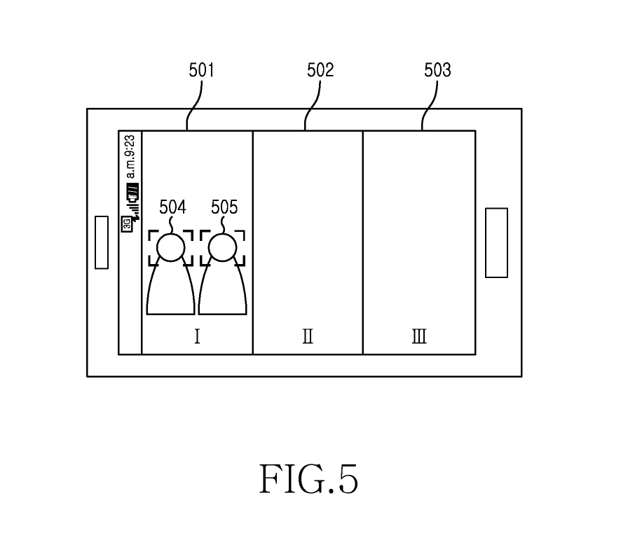

FIG. 5 illustrates an example of determining a speaker by using a gain value, face recognition information, and frequency information according to an embodiment of the present invention.

As shown in FIG. 5, an electronic device may divide the display of the electronic device into first to third areas 501, 502, and 503, and thereafter may confirm that a first subject 504 and a second subject 505 are included in the first area 501 among the divided three areas 501, 502, and 503. In FIG. 5, the areas are divided based on different decibel ranges.

According to an embodiment of the present invention, the electronic device may compare gain values acquired from at least two microphones, and may confirm that a value resulting from comparing the compared gain values is included in any one of decibel ranges of decibel areas, which are configured to correspond to the divided areas. For example, as shown in FIG. 5, when dual microphones are equipped in the electronic device, the display of the electronic device is divided into the three areas 501, 502, and 503, which correspond to a decibel area 501 having a decibel range beyond 20 db, a decibel area 502 having a decibel range between 0 db and 20 db, and a decibel area 503 having a decibel range between −20 db and 0 db, respectively.

In the aforementioned example, if the value resulting from comparing the gain values is 25 db, the electronic device may confirm that an area matched with the decibel area having a decibel range beyond 20 db is the first decibel area 501 among the divided three areas 501, 502, and 503.

According to an embodiment of the present invention, the electronic device may determine a subject included in the confirmed area matched with the decibel area as the speaker. In the aforementioned example, the electronic device may determine any one of the first subject 504 and second subject 505 included in the first decibel area 501 as the speaker.

According to an embodiment of the present invention, the electronic device may acquire face recognition information and frequency information, and may determine any one of two or more subjects as the speaker. According to an embodiment of the present invention, after acquiring frequency information of voices acquired from at least two microphones, if the acquired frequency information of the voices is lower than a pre-set frequency, the electronic device may determine a gender of the subject as a male or determine an age of the subject as an adult. According to another embodiment of the present invention, after acquiring the frequency information of the voices acquired from the at least two microphones, if the acquired frequency information of the voices is greater than or equal to the pre-set frequency, the electronic device may determine the gender of the subject as a female or determine the age of the subject as a minor.

As shown in FIG. 5, when the first subject 504 and the second subject 505 are detected in the first area 501 of the electronic device, frequency information of the acquired voice is detected to be lower than pre-set frequency information, and as a result of executing the face recognition function, the first subject 504 is detected as a male, and the second subject 505 is detected as a female. In the aforementioned example, since the voices acquired in the electronic device is detected to have a frequency lower than a pre-set frequency and the first subject 504 is detected as the male through the face recognition function, the first subject 504 may be determined as the speaker.

According to an embodiment of the present invention, the electronic device may analyze an image of a subject included in a captured content, and may determine a speaker by using mouth shape information of the subject. According to an embodiment of the present invention, when the electronic device determines a speaker through an image or motion picture capture, the electronic device may determine the speaker using a mouth shape of a subject.

According to an embodiment of the present invention, the electronic device may convert a voice of a determined speaker into a text by using a Speech To Text (STT) technique, and thereafter may list the converted text. According to an embodiment of the present invention, the electronic device may convert an acquired voice into a text by using the STT technique, and thereafter may store the converted text in a list form.

According to an embodiment of the present invention, the electronic device may display the text stored in the list form in a pre-set area of the display that is displaying the determined speaker. According to an embodiment of the present invention, regarding the pre-set area, an area large enough to display the text around the determined speaker may be used as the pre-set area. According to an embodiment of the present invention, the pre-set area may include any one of upper, lower, left, and right areas around the determined speaker being displayed.

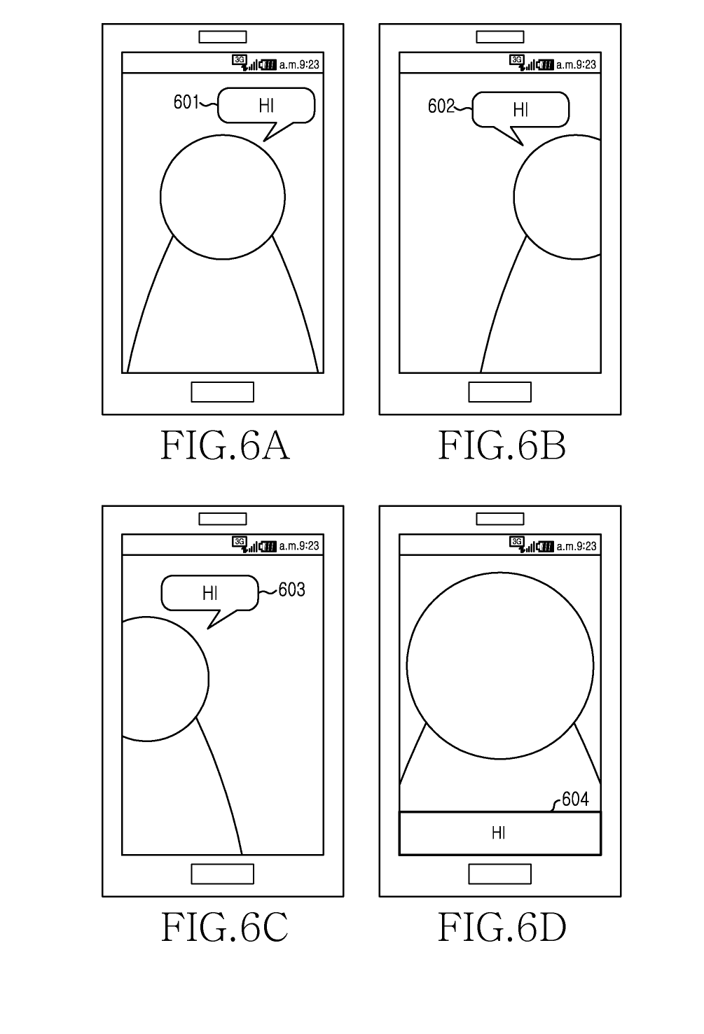

FIG. 6 illustrates an example of displaying a voice of a speaker in a text format according to an embodiment of the present invention.

Hereinafter, referring to FIG. 6, it will be described that, if there is an empty area having the same size as the pre-set area around the speaker, it is configured to display a text in the order of in upper, right, left, and lower areas.

According to an embodiment of the present invention, as shown in FIG. 6A, after a speaker is determined in an electronic device, if a speaker's voice “hi” is converted into a text, the electronic device may confirm that there is an empty area having the same size as a pre-set area in an upper area configured with a first priority to display the text around the speaker. The electronic device may display the speaker's voice “hi” in a text format 601 in the upper area around the speaker.

According to an embodiment of the present invention, as shown in FIG. 6B, after a speaker is determined in an electronic device, if a speaker's voice “hi” is converted into a text, the electronic device may confirm that there is no empty area having the same size as a pre-set area in an upper area with a first priority. The electronic device may confirm that there is an empty area having the same size as a pre-set area in a right area configured with a second priority to display the text around the speaker, and may display the speaker's voice “hi” in a text format 602 in the right area around the speaker.

According to an embodiment of the present invention, as shown in FIG. 6C, after a speaker is determined in an electronic device, if a speaker's voice “hi” is converted into a text, the electronic device may confirm that there is no empty area having the same size as a pre-set area in an upper area with a first priority and in a right area with a second priority. The electronic device may confirm that there is an empty area having the same size as a pre-set area in a left area configured with a third priority to display the text around the speaker, and may display the speaker's voice “hi” in a text format 603 in the left area around the speaker.

According to an embodiment, as shown in FIG. 6D, after a speaker is determined in an electronic device, if a speaker's voice “hi” is converted into a text, the electronic device may confirm that there is no empty area having the same size as a pre-set area in an upper area with a first priority, in a right area with a second priority, and in a left area with a third priority. The electronic device may confirm that there is an empty area having the same size as a pre-set area in a lower area configured with a fourth priority to display the text around the speaker, and may display the speaker's voice “hi” in a text format 604 in the lower area around the speaker.

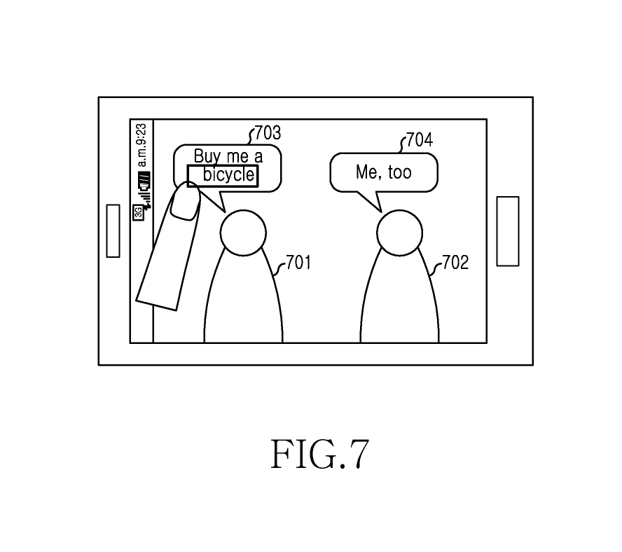

FIG. 7 illustrates an example of selecting a displayed speaker's voice according to an embodiment of the present invention.

According to various embodiments, an electronic device may display a speaker's voice in a text format in a pre-set area of a determined speaker. For example, as shown in FIG. 7, the electronic device may display a voice “buy me a bicycle” spoken from a 1^{st} subject 701 in a text format 703, and may display a voice “me, too” spoken from a 2^{nd} subject 702 in a text format 704.

According to an embodiment of the present invention, if a text displayed in a display is selected, the electronic device may access a web browser related to the selected text. For example, after the electronic device displays a text “A” in the display, if the text “A” is selected by a user, the electronic device may access an Internet site related to “A”.

As shown in FIG. 7, the electronic device may display the text “buy me a bicycle” spoken from the first subject 701, and if a text “bicycle” is selected, the electronic device may display information related to the bicycle. According to an embodiment of the present invention, the electronic device may display information such as on-line or off-line store related to a variety of bicycles, information regarding the variety of bicycles, and a dictionary definition on the bicycle.

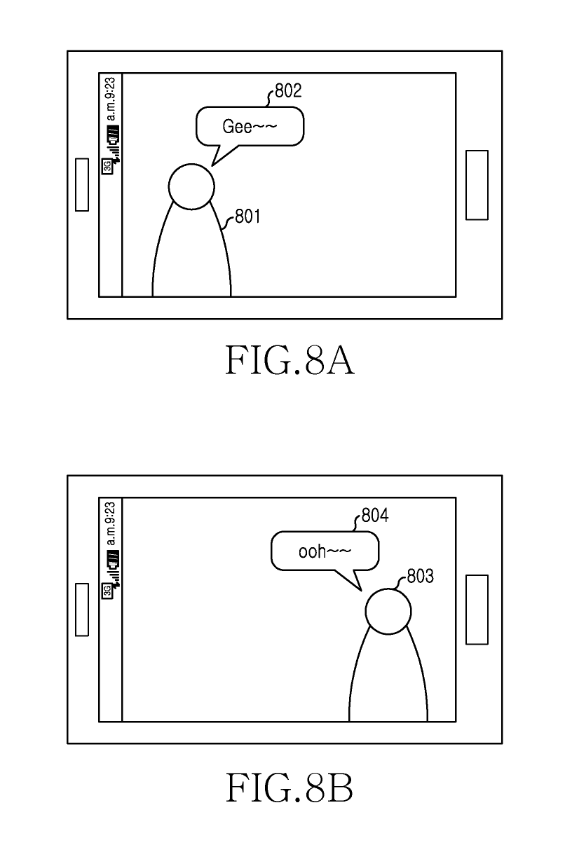

FIG. 8 illustrates an example of displaying a speaker's voice in a text format on the basis of a pre-set priority according to an embodiment of the present invention.

According to various embodiments, the electronic device may display the text stored in the list form in a pre-set area of the determined speaker. According to an embodiment, if there is an empty area having the same size as a pre-set space among upper, lower, left, and right areas around the determined speaker, the pre-set area may be an area determined on the basis of a determined order among the upper, lower, left, and right areas.

According to an embodiment of the present invention, a priority of a text may be set, and if there is a text of which a priority is set among the list-up texts, the electronic device may display the text according to the priority in the pre-set area.

According to an embodiment of the present invention, a priority of a voice may be set, and if the electronic device is configured to display voices acquired from at least two microphones equipped in the electronic device by giving a higher priority to a voice having a frequency higher than a pre-set frequency, the electronic device may preferentially display the voice having the frequency higher than the pre-set frequency in a display of the electronic device.

As shown in FIG. 8A, if an electronic device detects that a voice “gee” spoken from a first subject 801 of the electronic device has a frequency higher than a pre-set frequency, the electronic device may preferentially display the voice “gee” in a text format 802.

According to an embodiment of the present invention, a priority of a voice may be set, and if the electronic device is configured to display voices acquired from at least two microphones equipped in the electronic device by giving a higher priority to a voice having a frequency lower than a pre-set frequency, the electronic device may preferentially display the voice having the frequency lower than the pre-set frequency in a display of the electronic device.

As shown in FIG. 8B, if an electronic device detects that a voice “ooh” spoken from a second subject 803 of the electronic device has a frequency lower than a pre-set frequency, the electronic device may preferentially display the voice “ooh” in a text format 803.

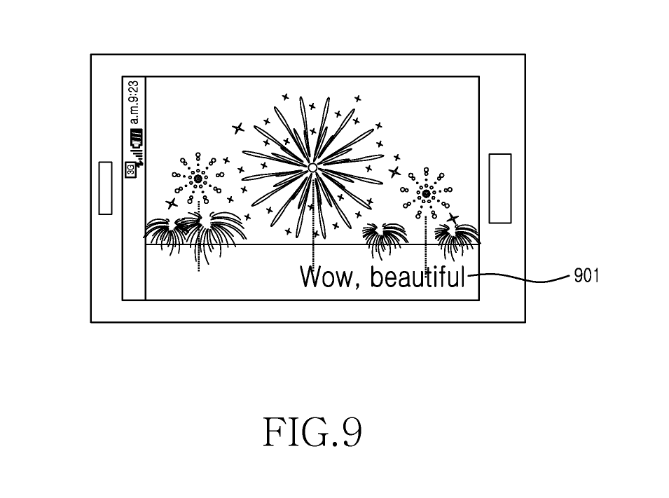

FIG. 9 illustrates an example of displaying a speaker's voice in a text format when a speaker is not displayed in a displayed subject according to an embodiment of the present invention.

According to an embodiment of the present invention, if the electronic device does not detect the speaker among subjects displayed in a display of the electronic device, the electronic device may display an acquired voice in a pre-set area by converting the voice in a text format.

As shown in FIG. 9, if a voice “wow, beautiful” is spoken while a user of an electronic device captures a video in which a firecracker goes off, since only the video in which the firecracker goes off is displayed in the electronic device, it can be confirmed that the speaker is not included in a display. The electronic device may display a voice such as “wow, beautiful” in a pre-set lower area by converting the voice in a text format 901.

According to an embodiment of the present invention, when a voice spoken from a subject (or a determined speaker) displayed in an electronic device is displayed in a text format, if a location of the subject is changed (e.g., if the subject moves, or in the case of an augmented reality, if the electronic device moves, etc.), the displayed text may also move together with the subject.

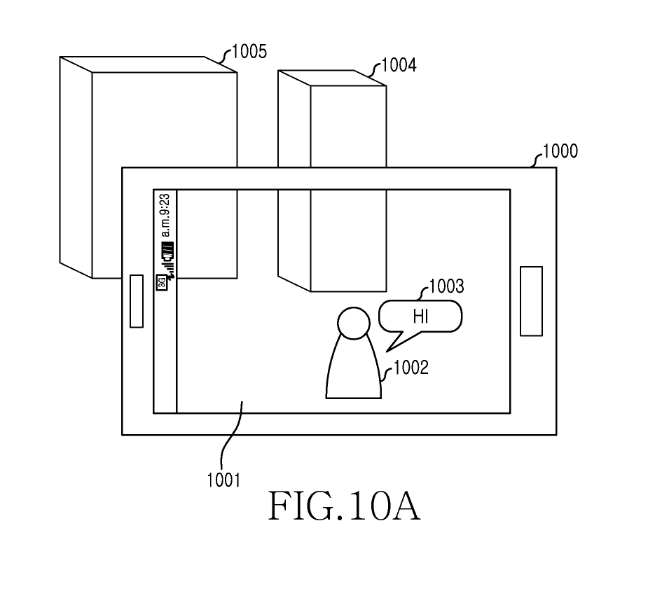

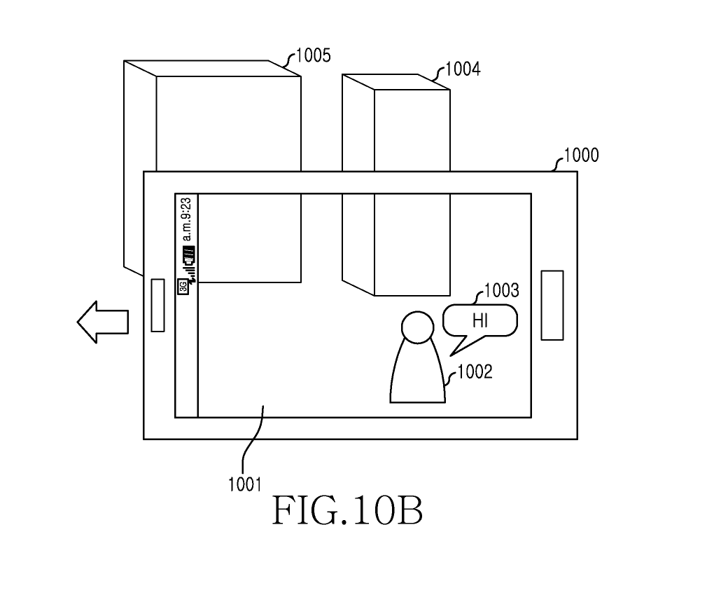

FIG. 10A and FIG. 10B display an augmented reality of an electronic device according to an embodiment of the present invention.

As shown in FIG. 10A, when a speaker 1002 is displayed in a display 1001 of an electronic device 1000 together with a plurality of subjects (e.g., buildings 1004 and 1005), a voice spoken from the speaker 1002 may be displayed in a text format 1003 through STT conversion as described above. In this case, the text 1003 may be arranged in at least one available area of the display of the electronic device 1000.

As shown in FIG. 10B, if the electronic device moves in an arrow direction, it may be controlled such that a plurality of subjects 1004 and 1005 move in the display 1001 of the electronic device 1000, whereas the speaker 1002 and the text 1003 displayed in a display 1001 maintain their locations. According to an embodiment of the present invention, if the electronic device 1000 does not move and only the speaker 1002 moves, the text 1003 may also move depending on the movement of the speaker 1002.

According to an embodiment of the present invention, a configuration of displaying a text corresponding to a speaker displayed in a display can be applied in various manner, for example, to a motion picture, a still image, etc., which are captured by a camera device.

According to an embodiment of the present invention, at least two microphones may be disposed to an outside of an electronic device, and a device (e.g., a wearable device or the like) including location information may receive voice and digital signals and may display the signals in a display of the electronic device.

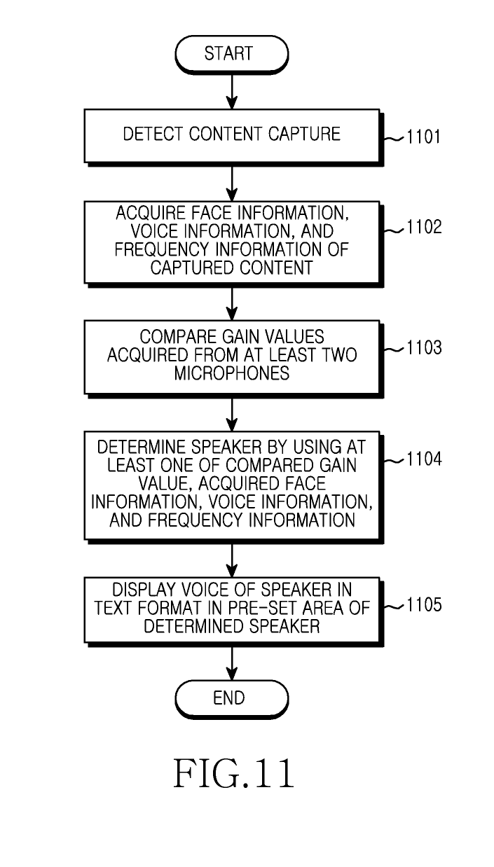

FIG. 11 is a flowchart illustrating an operation of an electronic device according to an embodiment of the present invention of the present invention.

As shown in FIG. 11, in step 1101, the electronic device detects a content capturing action. According to an embodiment of the present invention, if a content capturing action is detected in the electronic device, the electronic device may turn off a speaker of the electronic device while executing at least two microphones. According to an embodiment of the present invention, the electronic device may start a face recognition function of a subject while displaying the preview image.

In step 1102, the electronic device acquires at least one of (voice) gain values, face information, voice information, (voice) frequency information, or the like of the captured content.

In step 1103, the electronic device compares gain values acquired from the at least two microphones. According to an embodiment of the present invention, the electronic device having dual microphones may subtract a gain value acquired from a second microphone from a gain value acquired from a first microphone.

In step 1104, the electronic device may determine the speaker by using at least one of the compared gain values and the acquired face information, voice information, and frequency information. According to an embodiment of the present invention, the electronic device may compare gain values acquired from at least two microphones, and may confirm that a value resulting from comparing the gain values is included in any one of decibel ranges of decibel areas which are configured to correspond to the divided areas. According to an embodiment of the present invention, the electronic device may determine a speaker by matching face recognition information of a subject recognized from a face recognition function and location information of a subject based on a voice acquired from a microphone. According to an embodiment of the present invention, after acquiring frequency information of voices acquired from at least two microphones, if the acquired frequency information of the voice is lower than a pre-set frequency, the electronic device may determine a gender of the speaker as a male or determine an age of the subject as an adult. According to another embodiment of the present invention, after acquiring the frequency information of the voices acquired from the at least two microphones, if the acquired frequency information of the voice is greater than or equal to the pre-set frequency, the electronic device may determine the gender of the speaker as a female or determine the age of the subject as a minor. According to an embodiment of the present invention, the electronic device may determine a subject as the speaker, by using the acquired face information, voice information, frequency information, or the like.

In step 1105, the electronic device may display a speaker's voice in a text format in a pre-set area of a display that is displaying a determined speaker. According to an embodiment of the present invention, if there is an empty area having the same size as a pre-set area among upper, lower, left, and right areas around the determined speaker, the pre-set area may be an area determined on the basis of a determined order among the upper, lower, left, and right areas.

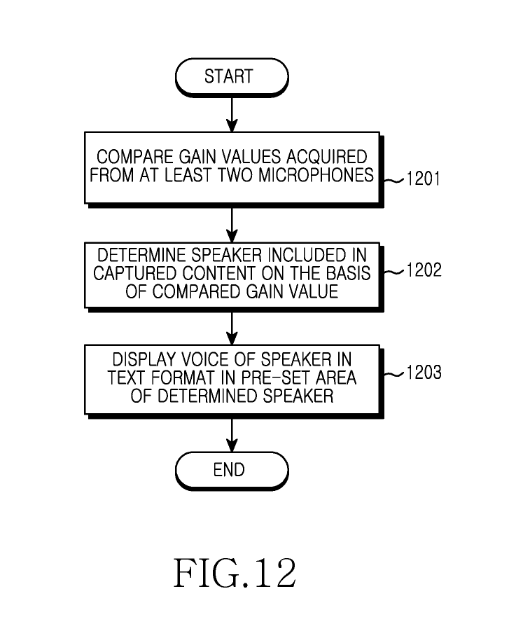

FIG. 12 is a flowchart illustrating a method of an electronic device according to an embodiment of the present invention.

As shown in FIG. 12, in step 1201, when the electronic device detects a content capturing action, the electronic device may compare gain values acquired from at least two microphones. According to an embodiment of the present invention, the electronic device having dual microphones may subtract a gain value acquired from a second microphone from a gain value acquired from a first microphone.

In step 1202, the electronic device may determine a speaker included in a captured content on the basis of the compared gain values. According to an embodiment of the present invention, the electronic device may compare gain values acquired from at least two microphones, and may confirm that a value resulting from comparing the gain values is included in any one of decibel ranges of decibel areas, which are configured to correspond to the divided areas. According to an embodiment of the present invention, the electronic device may determine a subject included in any one of the divided areas corresponding to pre-set decibel areas as the speaker, by including the acquired face information, voice information, frequency information, or the like.

In step 1203, the electronic device may display a speaker's voice in a text format in a pre-set area of a display that is displaying a determined speaker. According to an embodiment of the present invention, the electronic device may convert a voice of a determined speaker into a text by using a Speech To Text (STT) technique, and thereafter may list the converted text. According to an embodiment of the present invention, the electronic device may convert an acquired voice into a text by using the STT technique, and thereafter may store the converted text in a list form. According to an embodiment of the present invention, the electronic device may display the text stored in the list form in a pre-set area of a display that is displaying the determined speaker. According to an embodiment of the present invention, if there is an empty area having the same size as a pre-set area among upper, lower, left, and right areas around the determined speaker, the pre-set area may be an area determined on the basis of a determined order among the upper, lower, left, and right areas. According to an embodiment of the present invention, the electronic device may convert the voice of the determined speaker into a text and displaying the text in response to a selection for the at least one object.

According to an embodiment of the present invention of the present invention, a method of operating an electronic device may include, upon detecting a content capturing action, comparing gain values acquired on the basis of voices collected from at least two microphones, determining at least one speaker included in a displayed content on the basis of the compared gain values, and displaying a voice of the determined speaker in a text format in an area around the determined speaker.

The content capturing action may include displaying a preview image of the content and starting a face recognition function in the preview image.

Comparing the acquired gain value may include subtracting a gain value acquired on the basis of a voice collected from a second microphone among the at least two microphones from a gain value acquired on the basis of a voice collected from a first microphone among the at least two microphones.

Determining the speaker included in the content may include dividing the display into at least two areas, and confirming whether the at least one subject is included in at least one area among the divided areas.

The method may further include comparing the gain values acquired from the at least two microphones to confirm that a value resulting from comparing the gain values is included in any one of decibel ranges of decibel areas which are configured to correspond to the divided areas, detecting an area matched to the decibel area having a specific decibel range including the value resulting from comparing the gain values among the divided areas, and determining a subject included in the detected area as the speaker.

Determining the subject as the speaker may include, if at least two subjects are included in the detected area, acquiring face information of the at least two subjects through a face recognition function, and determining any one of the at least two subjects included in the detected area as the speaker.

Determining any one subject among the two or more subjects may include acquiring frequency information of voices acquired from the at least two microphones, and if the acquired frequency information of the voices is lower than a pre-set frequency, determining a gender of the speaker as a male or determining an age of the subject as an adult.

Determining any one subject among the two or more subjects may include acquiring frequency information of voices acquired from at least two microphones, and if the acquired frequency information of the voices is higher than or equal to the pre-set frequency, determining the gender of the speaker as a female or determining the age of the subject as a minor.

Displaying the voice of the determined speaker as the text may include converting the voice of the speaker into a text by using a Speech To Text (STT) technique, listing the converted text, and if there is a text of which a priority is set among the listed texts, preferentially displaying the text having the priority in the pre-set area.

If there is an empty area having the same size as the pre-set area among upper, lower, left, and right areas around the determined speaker, the pre-set area may be an area determined on the basis of a determined order among the upper, lower, left, and right areas.

An embodiment of the present invention of the present invention provide an apparatus and method in which a speaker included in a content is determined by using a gain value, face recognition information, voice frequency information, or the like acquired from at least two equipped microphones, and thereafter a voice of the speaker is displayed in a text format in a predetermined area, so that even a hearing-challenged person can easily check voice information.

According to various embodiments of the present invention, at least a part of an apparatus (e.g., modules or functions thereof) or method (e.g., operations) according to various embodiments of the present invention may be, for example, implemented by instructions stored in a non-transitory computer-readable storage media in a form of a programming module. When the instruction is executed by one or more processors, the one or more processors may perform functions corresponding to the instructions. The non-transitory computer-readable storage media may be the memory 230, for instance. At least a part of the programming module can be, for example, implemented (e.g., executed) by the processor 210. At least a part of the programming module can, for example, include a module, a program, a routine, a set of instructions, a process or the like for performing one or more functions.

The non-transitory computer-readable recording media may include magnetic media such as a hard disk, a floppy disk, and a magnetic tape, optical media such as a Compact Disc-ROM (CD-ROM) and a DVD, a Magneto-Optical Media such as a floptical disk, and a hardware device specially configured to store and perform a program instruction (e.g., the programming module) such as a ROM, a RAM, a flash memory and the like. Also, the program instruction may include not only a mechanical code such as a code made by a compiler but also a high-level language code executable by a computer using an interpreter and the like. The aforementioned hardware device may be constructed to operate as one or more software modules so as to perform operations of various embodiments of the present invention, and vice versa.

A module or a programming module according to various embodiments of the present invention may include at least one or more of the aforementioned constituent elements, or omit some of the aforementioned constituent elements, or include additional other constituent elements. Operations carried out by the module, the programming module or the other constituent elements according to the various embodiments of the present invention may be executed in a sequential, parallel, repeated or heuristic method. Also, some operations may be executed in different order or may be omitted, or other operations can be added.

While various embodiments the present invention of the present invention have been shown and described with reference to certain embodiments thereof, it will be understood by those skilled in the art that various changes in form and details may be made therein without departing from the spirit and scope of the present invention as defined by the appended claims and their equivalents. Therefore, the scope of the present invention is defined not by the detailed description of the various embodiments of the present invention but by the appended claims and their equivalents, and all differences within the scope will be construed as being included in the various embodiments of the present invention.

What is claimed is:

1. A method of operating an electronic device, the method comprising:
comparing gain values acquired on the basis of voices collected from at least two microphones;
determining at least one speaker included in a displayed content on the basis of the compared gain values; and
displaying a voice of the determined speaker in a text format in an area of a display around the determined speaker.

2. The method of claim 1, wherein displaying the content comprises:
displaying a preview image of the content; and
starting a face recognition function in the preview image.

3. The method of claim 1, wherein comparing the acquired gain values comprises subtracting a gain value acquired on the basis of a voice collected from a second microphone among the at least two microphones from a gain value acquired on the basis of a voice collected from a first microphone among the at least two microphones.

4. The method of claim 1, wherein determining the at least one speaker included in the displayed content comprises:
dividing the display into at least two areas; and
confirming whether the at least one speaker is included in at least one area among the divided areas.

5. The method of claim 4, further comprising:
confirming whether a value resulting from comparing the gain values is included in at least one of decibel ranges of pre-set decibel areas respectively corresponding to the divided areas; and
determining the speaker in an area including the compared gain value among the divided areas.

6. The method of claim 5, wherein determining the subject as the speaker comprises:
if at least two subjects are included in the at least one area among the divided areas, acquiring face information of the at least two subjects through a face recognition function; and
determining the at least one subject as the speaker on the basis of the acquired face information.

7. The method of claim 6, wherein determining the at least one subject comprises:
acquiring frequency information of the voices acquired from the at least two microphones;
if the acquired frequency information of the voices is lower than a pre-set frequency, determining a gender of the speaker as a male or determining an age of the subject as an adult; and
if the acquired frequency information of the voices is higher than or equal to the pre-set frequency, determining the gender of the speaker as a female or determining the age of the subject as a minor.

8. The method of claim 1, wherein displaying the voice of the determined speaker in the text format comprises:
displaying the determined speaker in at least one part of an area of the display; and
converting the voice of the determined speaker into a text and displaying the text.

9. The method of claim 1, wherein displaying the voice of the determined speaker in the text format comprises:
converting the voice of the determined speaker into a text by using a Speech To Text (STT) technique;
listing the converted text; and
if there is a text of which a priority is set among the listed texts, preferentially displaying the text having the priority in the area.

10. The method of claim 1, wherein if there is an empty area having the same size as a pre-set area among upper, lower, left, and right areas around the determined speaker, the area around the determined speaker is an area determined on the basis of a determined order among the upper, lower, left, and right areas.

11. An electronic device comprising:
a display; and
at least one processor operatively coupled to the display and configured to compare gain values acquired on the basis of voices collected from at least two microphones, to determine at least one speaker included in a displayed content on the basis of the compared gain values, to convert a voice of the determined speaker into a text, and to display the text in an area of the display around the determined speaker.

12. The electronic device of claim 11, wherein the at least one processor is further configured to display the content, and to display a preview image of the content and starting a face recognition function in the preview image.

13. The electronic device of claim 11, wherein the at least one processor is further configured to subtract a gain value acquired on the basis of a voice collected from a second microphone among the at least two microphones from a gain value acquired on the basis of a voice collected from a first microphone among the at least two microphones.

14. The electronic device of claim 11, wherein the at least one processor is further configured to divide the display into at least two areas, and to confirm whether at least one subject is included in at least one area among the divided areas.

15. The electronic device of claim 14, wherein the at least one processor is further configured to confirm whether a value resulting from comparing the gain values is included in at least one of decibel ranges of pre-set decibel areas respectively corresponding to the divided areas, and to determine the at least one subject as the speaker in the at least one area corresponding to the at least one of decibel ranges including the value resulting from comparing the gain values among the divided areas.

16. The electronic device of claim 15, wherein if at least two subjects are included in the at least one area among the divided areas, the at least one processor is further configured to acquire face information of the at least two subjects through a face recognition function, and to determine the at least one subject among the at least two subjects as the speaker on the basis of the acquired face information.

17. The electronic device of claim 16, wherein the at least one processor is further configured to acquire frequency information of the voices collected from the at least two microphones, and if the acquired frequency information of the voices is lower than a pre-set frequency, to determine a gender of the subject as a male or determine an age of the speaker as an adult, and if the acquired frequency information of the voices is higher than or equal to the pre-set frequency, to determine the gender of the speaker as a female or determine the age of the subject as a minor.

18. The electronic device of claim 11, wherein the at least one processor is further configured to display the determined speaker in at least one part of an area of the display.

19. The electronic device of claim 11, wherein the at least one processor is further configured to convert the voice of the determined speaker into the text by using a Speech To Text (STT) technique, to list the converted text, and if there is a text of which a priority is set among the listed texts, to preferentially display the text having the priority in the area.

20. The electronic device of claim 11, wherein if there is an empty area having the same size as a pre-set area among upper, lower, left, and right areas around the determined speaker, the area around the determined speaker is an area determined on the basis of a determined order among the upper, lower, left, and right areas.
